(19) United States
(12) Patent Application Publication
(10) Pub. No.: US 2022/0036219 A1
(43) Pub. Date: Feb. 3, 2022

(54) SYSTEMS AND METHODS FOR FRAUD DETECTION USING GAME THEORY

(71) Applicant: JPMORGAN CHASE BANK, N.A., New York, NY (US)

(72) Inventors: Samuel Ayalew ASSEFA, Hoboken, NJ (US); Danial DERVOVIC, London (GB); Suchetha SIDDAGANGAPPA, Brooklyn, NY (US); Prashant P. REDDY, Madison, NJ (US); Maria Manuela VELOSO, Pittsburgh, PA (US); Parisa Hassanzadeh, Aston, PA (US)

(21) Appl. No.: 16/941,647

(22) Filed: Jul. 29, 2020

(51) Int. Cl. G06N 5/04; G06N 20/00; G06Q 30/00; G06Q 40/00; G06Q 40/02; G06Q 10/10; G06F 7/58

(52) U.S. Cl. CPC G06N 5/042; G06N 20/00; G06Q 30/0185; G06F 7/588; G06Q 40/02; G06Q 10/109; G06Q 40/12

(57) ABSTRACT

Systems and methods for applying game theory for fraud detection. Rather than inspecting every transaction record, embodiments are directed to limiting incoming suspicious transaction records according to a schedule. The schedule may define time windows for various clients and transactions. These time windows may filter down the stream of incoming transaction records to a subset. As a result, fraud may be detected by strategically allocating resources in an optimal way rather than attempting to inspect each and every instance of transaction.

### BACKGROUND OF THE INVENTION

### 1. Field of the Invention

Embodiments relate to systems and methods for detecting potentially fraudulent transactions between a purchaser and a vendor.

### 2. Description of the Related Art

Fraudulent transactions refer to when an entity uses fraud to initiate a transaction with a vendor. This involves the fraudulent entity (e.g., the fraudster) posing as a legitimate entity (e.g., an account owner) to initiate a transaction. One common type of fraud is for a fraudster to obtain a victim's account login details via email hacking, social engineering, phishing, etc. The fraudster then has access to victim's account to make transactions as they please. The fraudster can choose to initiate transactions using the compromised accounts that it controls (e.g., fraudulent transactions) or to try and conceal the fact the account is compromised by doing nothing, in which case, the victim initiates transactions as part of its normal practice (a non-fraudulent transaction).

Financial institutions provide fraud detection services to identify fraudulent transactions by monitoring the activity of potential victims. This may involve significant resources, particularly as the number of transactions scales.

### SUMMARY OF THE INVENTION

The present disclosure relates to applying game theory to improve fraud detection by strategically allocating resources. Rather than evaluating whether each transaction is fraudulent, the technical improvements to the functioning of computing systems are directed to efficiently deploying resources in an optimal manner to minimize fraud. For example, embodiments are directed to generating a schedule based on transaction history to limit the number of transactions under consideration.

Some embodiments involve receiving a transaction history comprising a plurality of transaction records for a client, each transaction record comprising a timestamp and an amount. A schedule may be generated for the client, where the schedule comprises at least one time window based on the transaction history. A set of incoming transaction records for the client is received. The set of incoming transactions may be filtered according to the at least one time window to generate a filtered set of records. The filtered set of records may be inputted into a fraud detection algorithm. The fraud detection algorithm may select at least one record associated with a potential fraudulent transaction. The selected records that have been associated with potential fraudulent transactions may be transmitted to a queue for an operator to review.

In some embodiments, generating the schedule includes applying at least a randomizing algorithm to determine the at least one time window. In other embodiments, generating the schedule includes applying a set of rules to determine the at least one time window. In yet other embodiments, generating the schedule includes a machine learning model to determine the at least one time window.

In some embodiments, the fraud detection algorithm applies a set of rules to select the at least one record associated with a potential fraudulent transaction. In other embodiments the fraud detection algorithm applies a machine learning model to select the at least one record associated with a potential fraudulent transaction.

In some embodiments, the plurality of transaction records are associated with a plurality of accounts of the client. Each transaction record may comprise an account identifier. In other embodiments, the transaction records are associated with a plurality of devices of the client. Each transaction record may comprise a device identifier.

In some embodiments, the transaction history comprises transaction records for a plurality of clients. The schedule may comprise a respective schedule for each of the clients. An identification of the plurality of clients may be received via a user interface, to generate the schedule.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a drawing of a networked environment according to various embodiments.

FIG. 2 is a diagram showing a transaction history in a networked environment according to various embodiments.

FIG. 3 is a diagram showing the generation of a schedule in a networked environment according to various embodiments.

FIG. 4 is a diagram showing the operation of fraud detection in a networked environment according to various embodiments.

FIG. 5 is a flowchart illustrating an example of the functionality to identify potentially fraudulent transactions in a networked environment according to various embodiments.

FIG. 6 is a schematic showing an example of an implementation of various embodiments in a computing system.

### DETAILED DESCRIPTION OF PREFERRED EMBODIMENTS

Exemplary embodiments will now be described in order to illustrate various features. The embodiments described herein are not intended to be limiting as to the scope, but rather are intended to provide examples of the components, use, and operation of the invention.

Before discussing implementation of embodiments in various software and computer components, the present disclosure provides a brief overview of the theoretical concepts related to various embodiments. The present disclosure aims to optimally allocate resources for fraud detection as opposed to indiscriminately analyzing every transaction for fraud. This improves upon preexisting computing solutions by intelligently allocating resources for fraud detection to allow for large scale fraud detection. As a result, rigorous manual checking of potentially fraudulent transactions may be reduced.

The level of sophistication in fraud is increasing. Fraud may be a result of email hacking, social engineering, phishing, etc. The present disclosure refers to the fraudulent party as the attacker and refers to the victim as the customer. The attacker may be an individual or entity who can control the customer's bank account or other financial account of the customer. The attacker may control the account by having fraudulently obtained access credentials (e.g., user name, password, mailing address, phone number, account number, social security number, and other security measures). The attacker may pose as the customer to initiate financial transactions. The attacker benefits by deploying the customer's funds of the customer's account in exchange for the attacker's financial gain.

Conventional fraud detection measures may apply global rules. As one example, a rule may determine whether two transactions are close in time but are relatively far apart in geography. Satisfying this rule may indicate fraud. The attacker may use sophisticated measures to reduce the likelihood that fraudulent transactions go undetected under conventional fraud monitoring systems. For example, the attacker may initiate transactions that involve a relatively small amount of funds, the attacker may initiate transactions at geographic locations near to the location of the customer, the attacker may initiate transactions in the day time when transactions are more likely to occur.

The present disclosure provides solutions to combat at least sophisticated fraudulent activity by applying game theory. In game theory, the problem is characterized as a game between the attacker and a defender. The present disclosure refers to a defender as an individual or entity who is responsible for fraud detection as part of a fraud detection service. The defender's objective is to catch fraudulent transactions while the attacker's objective is to continue initiating fraudulent transactions without being caught.

Embodiments apply principles of a Stackelberg competition between the attacker and the defender. A Stackelberg competition is a type of game in game theory involving a first player referred to as the leader and second play referred to as the follower. The leader commits to a strategy before playing the game and the follower observes the leader's actions and takes an action. The leader knows that the follower will take an action after the leader takes action. In addition, a Stackelberg competition is a turn-based or sequential game as opposed to one where the players take action simultaneously. The present disclosure implements fraud detection in computing systems by modeling it according to a Stackelberg competition between the attacker (e.g., leader) and the defender (e.g., follower).

When modeling fraud detection after a Stackelberg competition, each account or transaction may be represented in a flexible data structure and the attacker is assumed to compromise a subset of accounts or transactions. In addition, an important variable in the Stackelberg game is capacity. For the attacker, the maximum capacity is the total number of accounts or transactions. For the defender, capacity refers to the quantification of the defender's resources for inspecting each transaction. Embodiments are directed to applying the concept of capacity in a Stackelberg competition to fraud detection. For example, by reducing the subset of transactions under consideration, the defender can better allocate resources in identifying fraudulent activity.

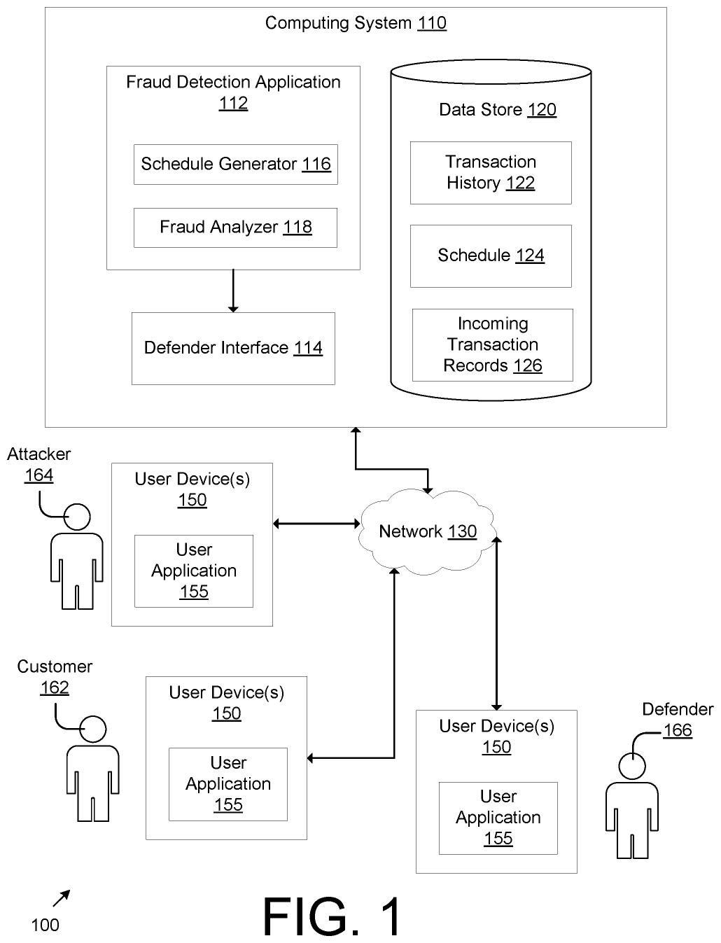

FIG. 1 shows a networked environment 100 according to various embodiments. The networked environment 100 includes a computing system 110. The computing system 110 may be an application server. The computing system 110 may be implemented as a server installation or any other system providing computing capability. Alternatively, the computing system 110 may employ a plurality of computing devices that may be arranged, for example, in one or more server banks or computer banks or other arrangements. Such computing devices may be located in a single installation or may be distributed among many different geographical locations. For example, the computing system 110 may include a plurality of computing devices that together may comprise a hosted computing resource, a grid computing resource, and/or any other distributed computing arrangement. In some embodiments, the computing system 110 may correspond to an elastic computing resource where the allotted capacity of processing, network, storage, or other computing-related resources may vary over time. The computing system 110 may implement one or more virtual machines that use the resources of the computing system 110.

The computing system 110 may be operated or otherwise controlled by a financial institution or other entity responsible for providing fraud detection services. The computing system 110 executes a variety of software components including, for example, a fraud detection application 112 and a defender interface 114. The fraud detection application 112 embodies various functionality according to the present disclosure. The fraud detection application 112 may include a schedule generator 116 and a fraud analyzer 118. The schedule generator 116 applies various principles of game theory by generating a schedule that filters transaction records into a subset. In this respect, the subset of transaction records match a target capacity for inspecting individual transaction records. The fraud analyzer 118 may operate as a server-side application or cloud-based service to detect whether a particular transaction record is associated with fraud.

The defender interface 114 may be a software component that provides a portal or other user interface to an entity/individual referred to as a defender. The defender interface 114 may comprise a queue for storing potential fraudulent records for review by a defender. The fraud detection application 112 may transmit potentially fraudulent records to the defender interface 114.

The computing system 110 may also include a data store 120. The data store 120 may represent one or more data stores. The data store 120 may comprise one or more databases. The software components executing in the computing system 110 (e.g., fraud detection application 112 and defender interface 114, etc.) may be configured to access the data store 120, read its contents, write to the data store 120, modify, edit, query, or update the contents of the data store 120.

The data store 120 may include a transaction history 122, a schedule 124, incoming transaction records 126, and potentially other data.

The transaction history 122 may contain a set of records, where each record represents a transaction. As used herein, a transaction involves the exchange of goods or services for some amount of funds. A transaction occurs electronically when one party (e.g., the customer) agrees to provide funds from an electronic account to a vendor/client and the vendor agrees to provide a good or service in return. The data reflecting the transaction is stored as a record. The transaction history 122 may be a database, where each record is a database record organized in rows or columns and including field values.

The transaction history 122 may include records relating to transactions conducted by different clients. A client refers to a customer and multiple accounts associated with the customer. For example, a customer's checking account, banking account, and credit card account may all be associated together as a single client. In this embodiment, each transaction record may include an account identifier to indicate which account of the client is associated with the transaction. The account identifier may be a checking account number, a credit card number, a debit card number, etc. In other embodiments, a client may refer to a single account.

In other embodiments, a client may refer to a customer and a set of devices associated with that customer. For example, a customer may register a mobile phone, laptop, and tablet as separate devices associated with a single customer. Each device may have a device identifier. In this embodiment, the transaction records for a particular client include may refer to several different devices registered to the customer. Each transaction record may include a device identifier indicating which device initiated the transaction.

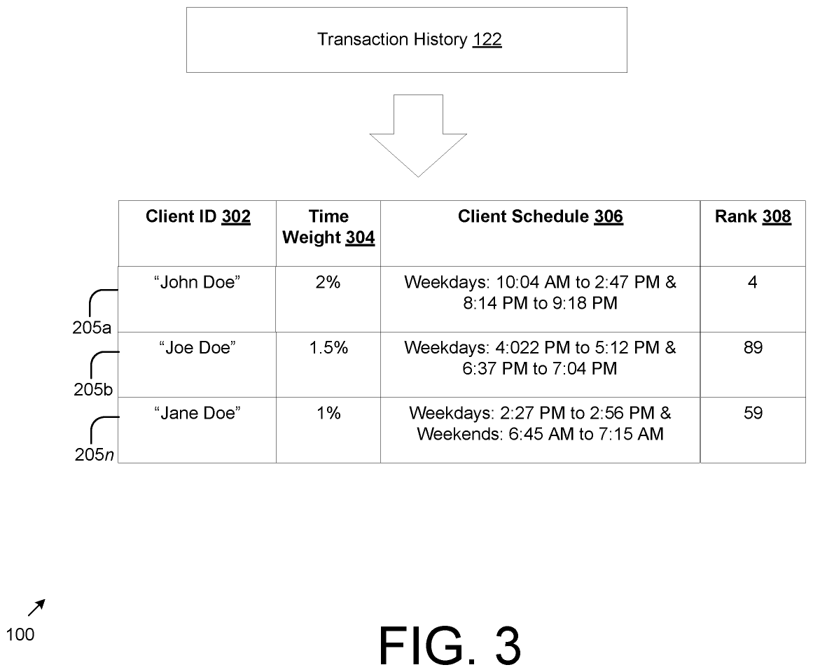

The schedule 124 may be generated by the schedule generator. The schedule 124 may contain various criteria for limiting the number of transaction records for each client based on the transaction history 122. In other words, the schedule 124 may include one or more time windows to filter down the transaction records of the client to fall only within the time window. The schedule 124 is discussed in more detail with respect to at least FIG. 3. The schedule 124 allows for the computing system 110 to control the capacity of the defender as the defender inspects various transaction records. In other words, by limiting the transaction records to a subset to match the defender may allocate fewer resources to identify fraud.

The data store 120 may also store incoming transaction records 126. Incoming transaction records may be streamed into the data store in real time as new transactions are made. Incoming transaction records 126 are subject to inspection for fraud detection. In some embodiments, the incoming transaction records may be eventually stored as transaction history 122.

The computing system 110 may be connected to a network 130. The network may be the Internet, intranet, or other communication networks. The network may be wireless network, wired network, or a combination thereof. The network 130 provides communication between endpoints connected to the network. Endpoints may communicate over the network using various communication protocols such as, for example, transmission control protocol/Internet protocol (TCP/IP).

The computing system 110 may operate as a server that serves various user devices 150. A user device 150 may be a client device that operates in a client-server configuration with respect to the computing system 110. A user device 150 may be a mobile device, laptop, desktop, tablet, smartphone, or other electronic device. The user device 150 may execute an operating system that supports various user applications 155. A user application may be a dedicated mobile application (e,g., an “app”), a web browser, or other application that executes in the user device 150. The user application may communicate with various server-side applications that execute in the computing system 110.

Some user devices 150 may be operated by customers 162. A customer may be an entity who uses the user device 150 to make purchases from vendors or otherwise send money to recipients. These purchases may be facilitated through a payment platform (e.g., an e-commerce platform, a payment service, etc.). Such platforms allow customers to submit payments to recipients. Commerce platforms or payment platforms may execute in servers that interface with user devices 150.

The user application 155 of a customer 162 may require the customer to authenticate himself/herself prior to initiating a financial transaction. Authentication refers to validating the identity of the customer. For example, the user application 155 may prompt the customer to provide a password, login credentials, biometric information, or other information to verify the customer's identity.

After authentication, the customer 162 may use the user application 155 to purchase goods and services or otherwise provide a payment. This may involve submitting information relating to a financial instrument (e.g., a credit card number, bank account number, debit card number, etc.) to a vendor over the network 130. The payment platform may communicate with the server of a financial institution to initiate the transfer of funds from the customer's account to an account of the vendor. This may result in the creation of a transaction record. The transaction record is transmitted to the data store 120 and stored as an incoming transaction record 126.

User devices 150 may also be operated by attackers 164. An attacker (e.g., fraudster) is a fraudulent party who may have obtained a customer's 162 login credentials, passwords, or other authentication information fraudulently. From the perspective of the payment platform, the attacker 164 is perceived as the customer 162 because the attacker 164 has information to authenticate with a user application 155 as the customer 162. While the customer 162 may initiate financial transactions using the customer's account (not-fraud), the attacker 164 may also initiate financial transactions using the customer's account (fraud). Both transactions result in the creation of transaction records that are received by the computing system 110 over the network 130. The attacker 164 may also take possession of the customer's user device 150 to make fraudulent transactions.

A defender 166 may also operate a user device 150. A defender 166 may be an operator, entity, or individual tasked with inspecting various transaction records to determine whether they were initiated as a result of fraud. The defender 166 may use a user application 155 that communicates with the defender interface 114 to receive transaction records for inspection. The defender 166 may inspect transaction records associated with transactions that were initiated by either or both of the customer 162 and the attacker 164 to decide which transactions were initiated by the attacker 164.

The following FIGS. provide an overview of various embodiments of fraud detection in a networked environment such as, for example, the network environment 100 depicted in FIG. 1.

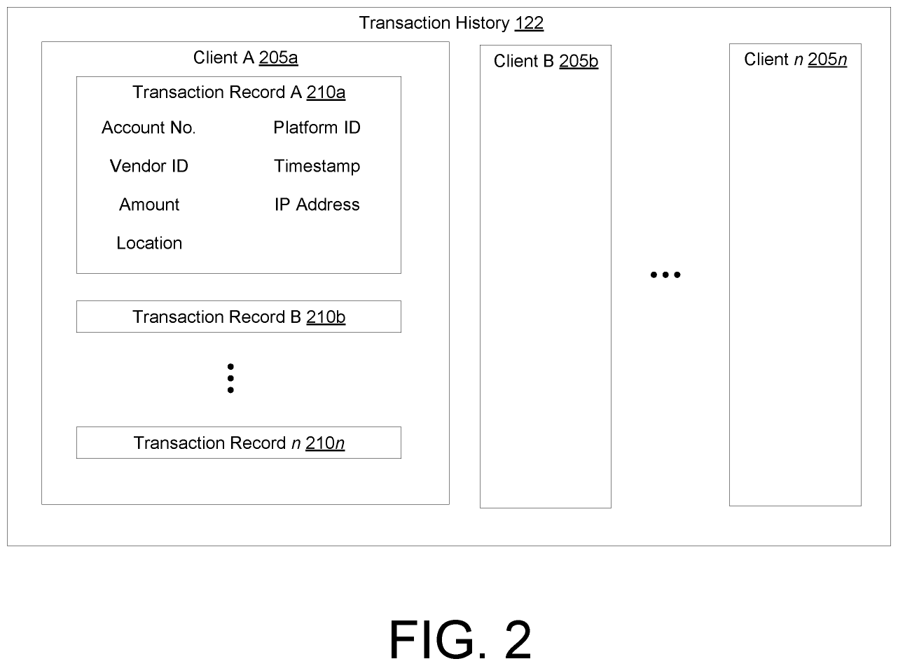

FIG. 2 is a diagram showing a transaction history 122 in a networked environment 100 according to various embodiments. The transaction history 122 may be generated by the fraud detection application 112. In some embodiments, the transaction history 122 is generated based on user-specified inputs such as a time range and/or an identification of clients. For example, a user interface provided at the user device 150 an identification of specific clients 205 and/or a time range to generate the transaction history 122. As discussed below with respect to FIG. 3., the transaction history 122 is used to generate a schedule 124.

The transaction history 122 may represent all transactions for a set of clients for a particular range of time. For example, the transaction history 122 may include all transactions for a one-month period. The example of FIG. 2 shows transactions for Client A 205a, Client B 205b and continuing through Client n 205n. In this respect, the transaction history 122 may include all transaction records for each of the clients 205a-n for a particular range of time.

A particular client may be associated with several transaction records 210. For example, Client A 205a may be associated with Transaction Record A 210a, Transaction Record B 210b, through Transaction Record n 210n. Transaction Record A 210a illustrates embodiments of data types that may be contained in a transaction record. A transaction record may include an account number, a vendor identifier, a transaction amount, a location, a platform identifier, a timestamp, an Internet Protocol (IP) address, or other information describing the characteristics of the transaction and the computing components responsible for carrying out the transaction.

The account number may identify a specific financial account (e.g., bank account, checking account, credit card account, etc.). This references the account containing the source of the funds involved in the transactions. The vendor identifier may identify the vendor or recipient of the funds. This may be a merchant ID or merchant name. The transaction amount may be the amount of funds that the customer 162 or attacker 164 agreed to transfer or pay to the vendor or recipient. The location may refer to the location of the customer 162 or attacker 164 at the time of making the transaction. The location may be obtained from the IP address of the user device 150 making the transaction, the location of a point-of-sale device that facilitated the transaction, or any other location associated with the transaction. The platform identifier may identify the software or hardware components used by the user device 150 to make the transaction. For example, the platform identifier may identify the operating system of the user device 150 making the transaction. The timestamp may be a timestamp applied a component in the network 130 that facilitates the communication of the transaction from the user device 150 to the payment platform. The timestamp represents the time the transaction was initiated by the customer 162 or attacker 164. The IP address specifies the IP address of the user device 150 making the transaction.

The transaction history 122 with respect to a specific client 205 may contain transaction records associated with fraud (e.g., fraudulently initiated by an attacker 164) and transaction records not associated with fraud (e.g., legitimately initiated by a customer 162). Applying fraud detection and inspecting each transaction record 210 in the transaction history 122 may be time consuming and not a strategic allocation of resources. As explained below, a schedule 124 is derived from the transaction history 122 to optimize fraud detection.

FIG. 3 is a diagram showing the generation of a schedule 124 in a networked environment 100 according to various embodiments. FIG. 3 illustrates a schedule generator 116 of a fraud detection application 112 that receives, as an input, a transaction history 122, and derives a schedule 124 from it. To generate the schedule 124, the fraud detection application 112 analyzes the transaction records for each client 205. The schedule 124 may include a client identifier 302 to identifier each client 205A-205n. The schedule 124 may include a weight 304 for each client. The weight 403 may be a percentage of transactions records to inspect or an absolute number to inspect. For example, a weight of 2% may reduce the total number of transaction records for a particular client 205 to only 2% of those transaction records to be inspected. In some embodiments, the schedule is generated by solving an optimization problem by taking the attacker and defender's utility into account. The utilities can be defined in various ways. For example, in one embodiment the utility may be calculated based on the expected gain in fraudulent funds for the attacker and the expected recovered fraudulent funds for the defender. The optimization problem may have constraints on the resources of the attacker and defender.

The schedule 124 may include a client schedule 306 for each client. The client schedule 306 identifies specific time windows for a client 205. A time window may have a start time and stop time for a particular day. The client schedule 306 indicates a time window where incoming transaction records 126 falling within the time window is to be inspected by a defender 166.

The schedule 124 may include a rank 308 for each client. The rank may identify which clients to prioritize over other clients when performing an inspection. For example, higher ranked clients (e.g., having a rank closer to “1”), should have their transaction records inspected before lower ranked clients.

To generate the schedule 124 a set of rules may be applied. For example, rules may be used to determine which clients are at higher risk of fraud. Rules may be based on the number or frequency of transactions, to a range of different devices used to make transactions, the types of vendors that are involved in transactions, or other rules to score a client with respect to fraud risk. As a result, clients that are subject to higher risks of fraud may be assigned a higher ranking 308 or have a larger weight 304. Similarly, the client schedule 306 may specify larger time windows based on these rules. As another example, the transaction history 122 for a client may be analyzed to determine when a particular client does not typically make transactions. For example, if the transaction history 122 indicates that a particular client historically does not make transactions from 10:04 AM to 2:47 PM on weekdays, then the client schedule 306 may be specified according to satisfying this rule. Rules may check for instances of light transaction activity to formulate the specific time windows. Thus the schedule 124 is generated by applying a set of rules to determine the time windows of the client schedule 306, the weights 304, the rankings 308, or other aspects of the schedule 124.

In some embodiments, the schedule is generated by applying a machine learning model to determine the time windows of the client schedule 306, the weights 304, the rankings 308, or other aspects of the schedule 124.

The machine learning module is configured according to training data for supervised learning. In some embodiments, the machine learning model may implement a classification related algorithm such as, for example, Naïve Bayes, (k-nearest neighbors) K-NN), support vector machine (SVM), Decision Trees, or Logistic Regression. In other embodiments, the machine learning model clusters related data without supervised learning. The machine learning model may implement a clustering related algorithm such as, for example, K-Means, Mean-Shift, density-based spatial clustering applications with noise (DBSCAN), or Fuzzy C-Means. In some embodiments, the machine learning model may implement a deep learning algorithm such as, for example, a convolutional neural network (CNN), recurrent neural network (RNN), a multilayer perception (MLP), or a generative adversarial network (GAN).

Each transaction record 210 in the transaction history 122 may be converted into a feature vector containing data indicative of various field-values in the transaction record 210. The training model may classify or cluster these feature vectors to classify or cluster their associated transaction records 210. Clients having transaction records that are classified or otherwise corresponding to a high risk of fraud. Such clients may be assigned a higher ranking 308 and/or giving a larger weight 304. In addition, the length of the time window may correspond to the risk of fraud determined by the machine learning model as it is applied to the transaction history 122. The machine learning model may also identify the start and stop times for the time window based on the transaction history 122.

In some embodiments a randomizing algorithm may be used, at least in part, in determining the schedule 124 for each client. A randomizing algorithm may include a random number generator. Some degree of randomization may be applied to determining the start and stop times of each time window, the length of the time window, the weight 304 and/or the ranking 308. A random number generator may be used in conjunction with a set of rules and/or a machine learning model to determine the schedule 124 for each client 205.

To generate the schedule 124, a user may specify, via a user interface rendered at a user device 150, the identity of specific clients as well as a time range for consideration. A transaction history 122 may be constructed based on these inputs, and accordingly, the schedule for the specified clients may be derived from the transaction history 122 according to these inputs.

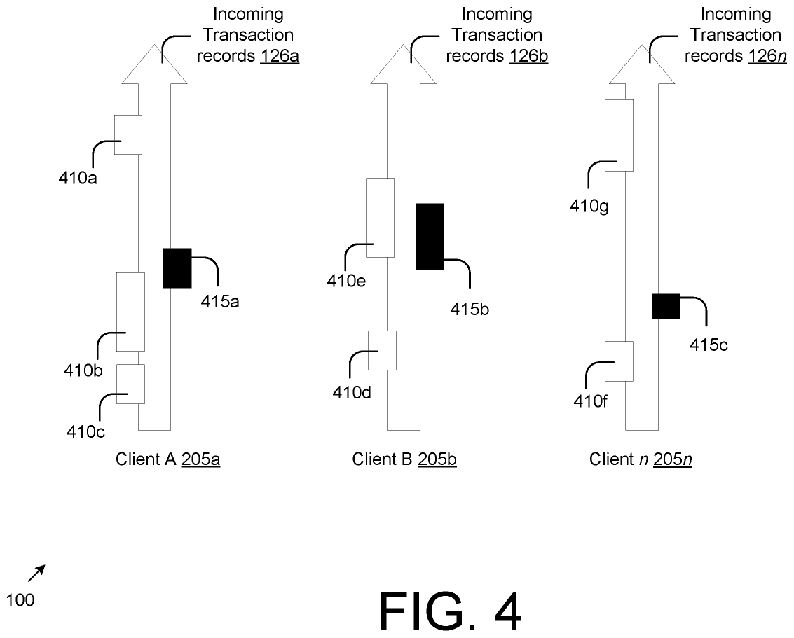

FIG. 4 is a diagram showing the operation of fraud detection in a networked environment 100 according to various embodiments. FIG. 4 shows the application of a schedule 124 to various clients 205a-n as incoming transaction records 126a-n are received for each client 205a-n. For example, Client A 205a is associated with a stream of incoming transaction records 126a, Client B 205b is associated with a stream of incoming transaction records 126b, and Client n 205n is associated with a stream of incoming transaction records 126n. Rather than reviewing each and every transaction record within the incoming transaction records 126a-n, the defender 166 may apply a schedule 124 to each of these incoming transaction records 126a-n. The schedule 124 may prioritize one client over the other according to a ranking 308. In addition, the subset of transaction records inspected by the defender 166 may be based on a weight 304 for each client 205a-n. In addition, the defender 166 may inspect only those transaction records falling within a time window 410a-f.

For example, when inspecting incoming transaction records 126a for Client A 205a, the defender 166 may inspect the transaction records falling within a first time window 410a, a second time window 410b, and a third time window 410c. This is shown in FIG. 4 as a vertical arrow where the bottom of the arrow represents the beginning of the stream of incoming transaction records 126 and the top of the arrow represents the end of the stream. The various time windows 410a-f shows sections along the arrow where an inspection occurs.

An inspection may involve a combination of an automated process and a manual process. The automated process may invoke a fraud analyzer 118 to analyze one or more transaction records for fraud detection. In this respect, the fraud analyzer may screen for transaction records that are associated with a threshold level of fraud. Thereafter, the defender 166 may manually inspect the transaction record for fraud.

FIG. 4 also shows fraudulent transaction records 415a-c as a solid black box that are contained within a stream of incoming transaction records. A fraudulent transaction record 415a-c is a transaction record that is associated with a transaction resulting from fraud. A first group of fraudulent transaction records 415a is present in the incoming transaction records 126a of Client A 205a. A defender is able to identify fraud in this example as the first group of fraudulent transaction records 415a occurs, at least partially, within the second time window 410b. Similarly, for Client B 205b, a second group of fraudulent transaction records 415b is detected by a defender 166 as it falls within a particular time window 410e defined by the schedule 124 for Client B 205b.

For Client n, a third group of fraudulent transaction records 415c goes undetected as it falls outside the time windows 410f, 410g for Client n. This illustrates how the objective to allocate resources to minimize fraud rather than to apply fraud detection to each and every transaction record.

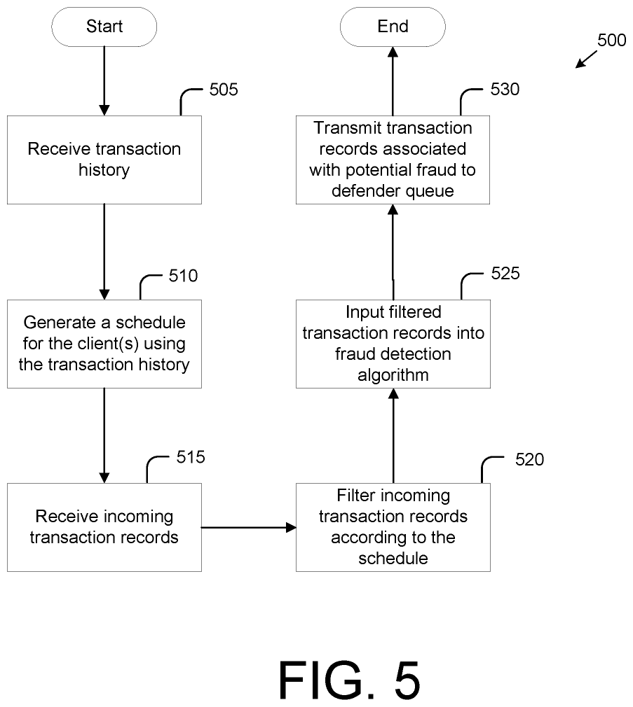

FIG. 5 is a flowchart illustrating an example of the functionality to identify potentially fraudulent transactions in a networked environment according to various embodiments. It is understood that the flowchart of FIG. 5 provides an illustrative example of the many different types of functional arrangements that may be employed to implement the operation of the portion of a computing system (e.g., the computing system 110 of FIG. 1) as described herein. The flowchart of FIG. 5 may also be viewed as depicting an example of a method 500 implemented in the networked environment 100 of FIG. 1 according to one or more embodiments.

At item 505, the computing system may receive a transaction history. The transaction history may include transaction records for multiple clients. The transaction history may be generated by a user-specified client list. The transaction history may also be generated by a user-specified time range. In this respect, the transaction history may be a customizable report containing a comprehensive list of transaction records that are used to determine how to detect fraud for newly received transaction records.

At item 510, the computing system may generate a schedule for each of the clients using the transaction history. The schedule may define how to select a subset of transaction records for each client by analyzing the comprehensive transaction history. The schedule may limit the number of transaction records by a percentage or absolute number. The schedule may priority one client over the other. The schedule may also include one or more time windows for each client. A time window may be characterized by a started and stop time as well as a length.

At item 515, the computing system may receive incoming transaction records. The incoming transaction records may be stored in a data store. The incoming transaction records are subject to fraud detection by applying the schedule.

At item 520, the computing system may filter the incoming transaction records according to the schedule. For example, the computing system may select the records in the incoming transaction records that fall within the time windows specified by the schedule. The computing system may also prioritize the order in which transaction records are to be inspected.

At item 525, the computing system may input the filtered transaction records into fraud detection algorithm. For example, a fraud analyzer may use a fraud detection algorithm to provide an initial screen or first-pass analysis of transaction records to determine whether they were initiated as a result of fraud. The fraud detection algorithm may provide a score or confidence level that a particular transaction record is associated with fraud.

In some embodiments, the fraud detection algorithm applies a set of rules to select transaction records associated with potential fraudulent transactions. For example, rules may be based on the location, timing, type of device, or other characters of the transaction to assess whether it is a result of fraud. For example, particular devices may be whitelisted or blacklisted. If a transaction is associated with a blacklisted device, as defined by a rule, then potential fraud may be detected.

In other embodiments, the fraud detection algorithm applies a machine learning model to select transaction records associated with potential fraudulent transactions. Machine learning models may be supervised or unsupervised to determine a fraud score associated with a particular transaction record. Each transaction record that has been filtered according to the schedule may be converted into a feature vector containing data indicative of various field-values in the transaction record. The training model may classify or cluster these feature vectors to classify or cluster their associated transaction records.

At item 530, the computing system transmits records associated with potential fraud to a defender queue. For example, once filtered transaction records are analyzed for fraud using an automated process (e.g., a fraud analyzer that employs a fraud detection algorithm), transaction records having a fraud score that exceeds a threshold score are transmitted to a defender queue for manual review by a defender. The defender may use a user device to access a defender interface to gain access to the defender queue.

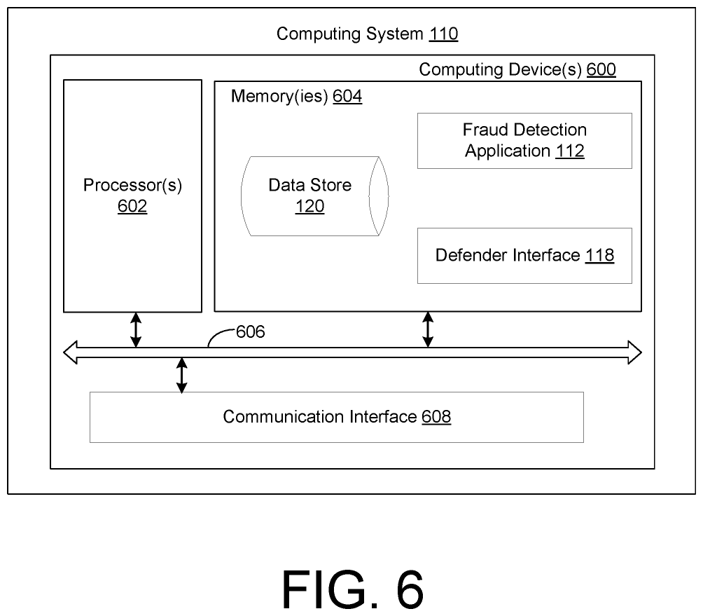

FIG. 6 is a schematic showing an example of an implementation of various embodiments in an initial computing system 110. The computing system 110 may refer to one or more computing devices 600 with distributed hardware and software to implement the functionality of the computing system 110.

The computing device 600 includes at least one processor circuit, for example, having a processor 602 and memory 604, both of which are coupled to a local interface 606 or bus. Stored in the memory 604 are both data and several components that are executable by the processor 602. For example, the memory 604 may store files, records, documents or streamed data. The memory may also include the initial data store 120.

Also stored in the memory 604 and executable by the processor 602 are software applications such as, for example, a fraud detection application 112 and defender interface 114. The software applications may implement the method 500 of FIG. 5.

It is understood that there may be other applications that are stored in the memory 604 and are executable by the processor 602 as can be appreciated. Where any component discussed herein is implemented in the form of software, any one of a number of programming languages may be employed, such as, for example, C, C++, C#, Objective C, Java®, JavaScript®, Perl, PHP, Visual Basic®, Python®, Ruby, or other programming languages.

Several software components are stored in the memory 604 and are executable by the processor 602. In this respect, the term “executable” means a program file that is in a form that can ultimately be run by the processor 602. Examples of executable programs may be, for example, a compiled program that can be translated into machine code in a format that can be loaded into a random access portion of the memory 604 and run by the processor 602, source code that may be expressed in proper format such as object code that is capable of being loaded into a random access portion of the memory 604 and executed by the processor 602, or source code that may be interpreted by another executable program to generate instructions in a random access portion of the memory 604 to be executed by the processor 602, etc. An executable program may be stored in any portion or component of the memory 604 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 604 is defined herein as including both volatile and nonvolatile memory and data storage components. Volatile components are those that do not retain data values upon loss of power. Nonvolatile components are those that retain data upon a loss of power. Thus, the memory 604 may comprise, for example, random access memory (RANI), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 602 may represent multiple processors 602 and/or multiple processor cores and the memory 604 may represent multiple memories 604 that operate in parallel processing circuits, respectively. In such a case, the local interface 606 may be an appropriate network that facilitates communication between any two of the multiple processors 602, between any processor 602 and any of the memories 604, or between any two of the memories 604, etc. The local interface 606 may couple to additional systems such as the communication interface 608 to coordinate communication with remote systems.

Although components described herein may be embodied in software or code executed by hardware as discussed above, as an alternative, the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc.

The flowcharts discussed above show the functionality and operation of an implementation of components within a system such as a fraud detection application 114, defender interface, or other software. If embodied in software, each box may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system, such as a processor 602 in a computer system or other system. The machine code may be converted from the source code, etc. If embodied in hardware, each block may represent a circuit or a number of interconnected circuits to implement the specified logical function(s).

Although the flowcharts show a specific order of execution, it is understood that the order of execution may differ from that which is depicted. For example, the order of execution of two or more boxes may be scrambled relative to the order shown. Also, two or more boxes shown in succession may be executed concurrently or with partial concurrence. Further, in some embodiments, one or more of the boxes may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

The components carrying out the operations of the flowcharts may also comprise software or code that can be embodied in any non-transitory computer-readable medium for use by or in connection with an instruction execution system such as, for example, a processor 602 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any program or application described herein, including the fraud detect application 112 and defender interface 114, may be implemented and structured in a variety of ways. For example, one or more applications described may be implemented as modules or components of a single application. Further, one or more applications described herein may be executed in shared or separate computing devices or a combination thereof. Additionally, it is understood that terms such as “application,” “service,” “system,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A computer-implemented method for detecting fraud, the method comprising:
receiving a transaction history comprising a plurality of transaction records for a client, each transaction record comprising a timestamp and an amount;
generating a schedule for the client comprising at least one time window based on the transaction history;
receiving a set of incoming transaction records for the client;
filtering the set of incoming transactions according to the at least one time window to generate a filtered set of records;
inputting the filtered set of records into a fraud detection algorithm, the fraud detection algorithm selecting at least one record associated with a potential fraudulent transaction; and
transmitting the at least one selected record to a queue.

2. The method of claim 1, wherein generating the schedule comprises applying at least a randomizing algorithm to determine the at least one time window.

3. The method of claim 1, wherein generating the schedule comprises applying a set of rules to determine the at least one time window.

4. The method of claim 1, wherein generating the schedule comprises applying a machine learning model to determine the at least one time window.

5. The method of claim 1, wherein the fraud detection algorithm applies a set of rules to select the at least one record associated with a potential fraudulent transaction.

6. The method of claim 1, wherein the fraud detection algorithm applies a machine learning model to select the at least one record associated with a potential fraudulent transaction.

7. The method of claim 1, wherein the plurality of transaction records are associated with a plurality of accounts of the client, wherein each transaction record comprises an account identifier.

8. The method of claim 1, wherein the plurality of transaction records are associated with a plurality of devices of the client, wherein each transaction record comprises a device identifier.

9. The method of claim 1, wherein the transaction history comprises transaction records for a plurality of clients, wherein the schedule comprises a respective schedule for each of the clients.

10. The method of claim 9, further comprising receiving via a user interface, an identification of the plurality of clients to generate the schedule.

11. A system comprising:
a processor; and
a memory coupled to a processor, the memory comprising a plurality of instructions, when executed, cause the processor to:
receive a transaction history comprising a plurality of transaction records for at a client, each transaction record comprising a timestamp and an amount;
generate a schedule for the client comprising at least one time window based on the transaction history;
receive a set of incoming transaction records for the client;
filter the set of incoming transactions according to the at least one time window to generate a filtered set of records;
input the filtered set of records into a fraud detection algorithm, the fraud detection algorithm configure to select at least one record associated with a potential fraudulent transaction; and
transmit the at least one selected record to a queue.

12. The system of claim 11, wherein the plurality of instructions, when executed, cause the processor to generate the schedule by applying at least a randomizing algorithm to determine the at least one time window.

13. The system of claim 11, wherein the plurality of instructions, when executed, cause the processor to generate the schedule by applying a set of rules to determine the at least one time window.

14. The system of claim 11, wherein the plurality of instructions, when executed, cause the processor to generate the schedule by applying a machine learning model to determine the at least one time window.

15. The system of claim 11, wherein the fraud detection algorithm applies a set of rules to select the at least one record associated with a potential fraudulent transaction.

16. The system of claim 11, wherein the fraud detection algorithm applies a machine learning model to select the at least one record associated with a potential fraudulent transaction.

17. The system of claim 11, wherein the plurality of transaction records are associated with a plurality of accounts of the client, wherein each transaction record comprises an account identifier.

18. The system of claim 11, wherein the plurality of transaction records are associated with a plurality of devices of the client, wherein each transaction record comprises a device identifier.

19. The system of claim 11, wherein the transaction history comprises transaction records for a plurality of clients, wherein the schedule comprises a respective schedule for each of the clients.

20. The system of claim 19, wherein the plurality of instructions, when executed, cause the processor to receive via a user interface, an identification of the plurality of clients to generate the schedule.
